(19) United States
(12) Patent Application Publication
(10) Pub. No.: US 2005/0219214 A1
(43) Pub. Date: Oct. 6, 2005

(54) Computer mouse for video game

(76) Inventor: Bertrand Marsac, Villeneuve (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/510,545

(22) PCT Filed: Apr. 8, 2003
(86) PCT No.: PCT/EP03/50094

§ 371 Date: Apr. 8, 2005

(30) Foreign Application Priority Data
Apr. 9, 2002 (FR) 0204428

(51) Int. Cl. G09G 5/08

(52) U.S. Cl. 345/163

(57) ABSTRACT

The invention concerns a computer mouse for video game comprising a housing (31), first and second action knobs (42, 43), characterized in that it comprises a dummy firing weapon (39) mounted on the housing (31) and maneuvered by a video game player and in that the first action knob (42) is located on the firing weapon, at the site where is located the player's forefinger, and the second action knob is located on the firing weapon, at the site where is located the player's thumb. The invention is applicable in the field of video game.

The invention relates to a computer mouse for video games and, in particular, for shooting games with a firing weapon such as a gun. This computer mouse is topped by a dummy firing weapon, integrating the action buttons.

The invention finds application in the domain of video games, and in particular, in video games on a personal computer or on a games console.

### PRIOR ART

Currently, in the domain of video games, numerous types of game peripherals exist. For example, there are paddles, joysticks or even computer mice. Each of these game peripherals is adapted to one or more types of games. Among these types of games, there are shooting games, in which the player plays the role of a person with a weapon firing on the characters or objects scrolling past on the video game display device, that is, on the computer screen or television screen to which the games console is connected. Currently, the shooting, that is, the simulation of the shooting action, is performed by means of a computer mouse. The shooting and rearming actions are done by clicking on one or the other of the action buttons of the computer mouse, also called the mouse buttons.

However, the position of the player's hand on the computer mouse has nothing in common with the position of a hand on a firing weapon such as a gun. In fact, with a computer mouse, the player places his hand flat on the mouse, uses the scroll wheel to choose the different options in the video game and clicks, with his index and middle fingers, on the left and right action buttons of the mouse to implement the shooting and rearming functions. On the contrary, when he holds an individual firing weapon, such as a gun, the player has his hand closed around the grip of the weapon with the index finger on the trigger and the thumb on the retainer of the weapon magazine. The position of the player's hand and the movements of the player's fingers are thus totally different when he handles a computer mouse and when he holds a weapon.

Such being the case, one of the goals of video games is to allow the player to be an actor in the game scenario. In particular, in shooting games, the player must be able to take the place of the shooter. Such being the case, the act of manipulating a computer mouse instead of a firing weapon takes away a large part of the player's involvement in the game scenario.

The computer mouse only allows the moment of the shooting to be simulated. The mouse does not allow the holding of the weapon as well as the total command of the shooting, that is, the action of the player's fingers on the weapon at the moment of shooting, the moment of shooting and the mechanical movements of the weapon at the moment of shooting to be simulated.

### STATEMENT OF THE INVENTION

The object of the invention is precisely to allow a simulation in the holding of the weapon as well as a simulation of the total command of a shooting in a video game, the simulation is done as well in the shooting command as in the mechanical movements of the weapon. To do this, the invention proposes a computer mouse topped by a dummy firing weapon, in which the shooting and rearming functions are performed from the trigger and retainer of the weapon.

More precisely, the invention relates to a computer mouse for video games, comprising a housing, a first and second action button, characterized in that the mouse comprises a dummy firing weapon topping the housing and manipulated by a video game player and in that the first action button is situated on the weapon, at the location where the player's index finger is placed, and the second action button is situated on the weapon, at the location where the player's thumb is placed.

### BRIEF DESCRIPTION OF THE FIGURES

FIG. 1 schematically represents the computer mouse of the invention facing a video game display screen.

FIG. 2 represents an exploded [sic] view of a computer mouse according to the invention.

### DETAILED DESCRIPTION OF THE EMBODIMENTS OF THE INVENTION

The invention relates to a computer mouse used as a game peripheral during the execution of a video game on a personal computer or a games console connected to a television screen. It is to be noted that, in the case of a computer, the mouse of the invention may also be used as a conventional mouse for software other than video games.

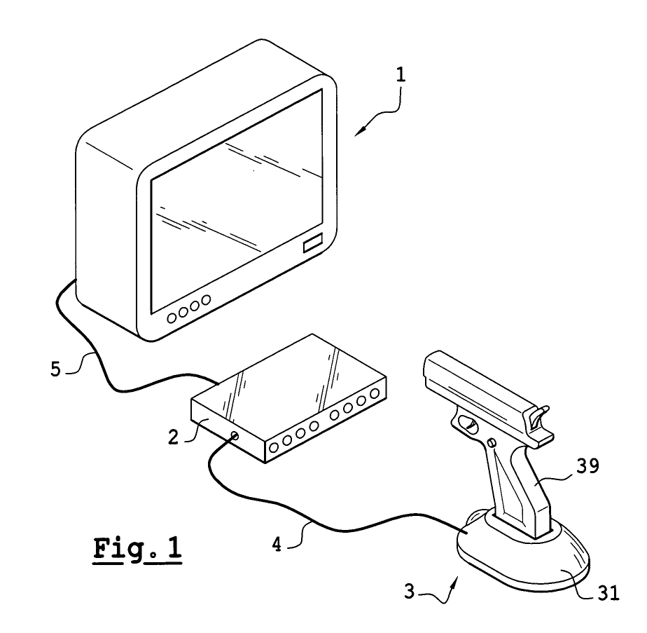

FIG. 1 represents a computer mouse according to the invention, facing a television screen 1 connected by a wire connection 5 to a games console 2 that executes a shooting video game. In this FIG. 1, the computer mouse 3 is connected to the games console 2 by a connection wire 4. The wire connection of the computer mouse to the games console (or to a computer) is not the only possible connection method. In fact, as with conventional computer mice, the mouse 3 of the invention may be a wireless mouse connected to the console 2 (or to a computer) by radio or infrared means. The mouse may also be a mouse operating by detection of the hand moving in space due to motion sensors.

The computer mouse of the invention comprises a housing 31 roughly having the shape of a conventional computer mouse. The housing 31 is topped by a dummy firing weapon 39. This dummy weapon may be any individual firing or laser ray weapon. This may be, for example, a gun or any type of handgun such as a revolver or a submachine gun. This firing weapon 39 may be a replica of a weapon that exists or used to exist. The weapon may also be a model of a fantasy weapon, such as a weapon created for a cinematographic film or a weapon specifically created for video games.

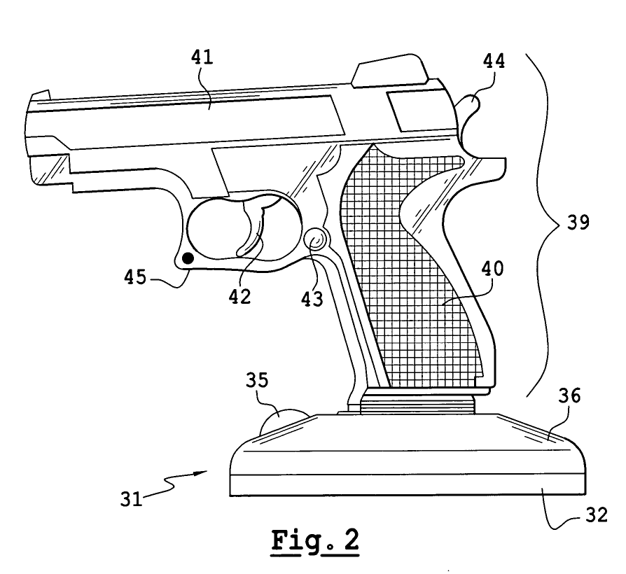

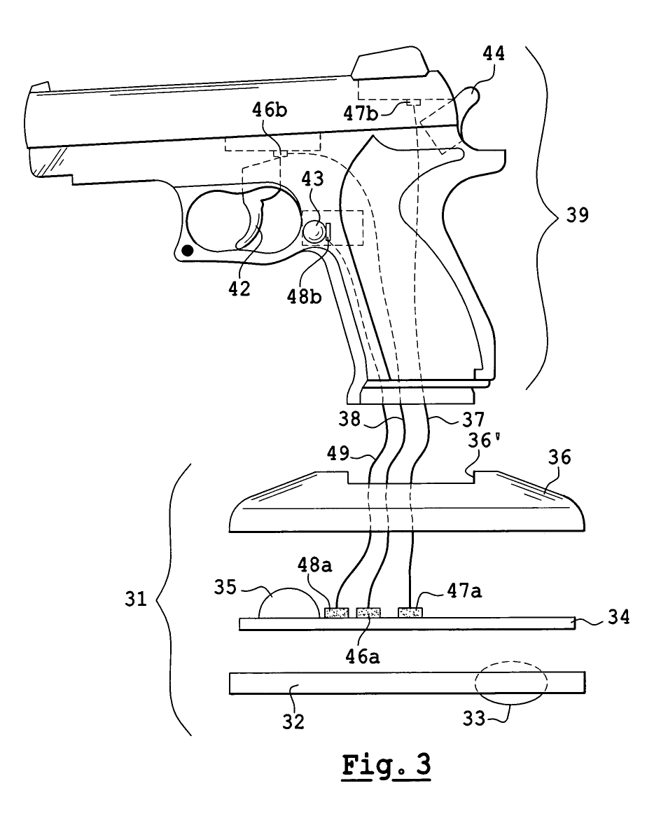

In FIG. 2 is represented the mouse of the invention with the housing 31 and the dummy firing weapon 39. As with a conventional weapon, the dummy firing weapon 39 of the mouse of the invention comprises a cannon 41, a grip 40 around which the player places his hand, a trigger guard 45 in which the player introduces his index finger and a trigger 42, that is mobile inside the trigger guard 45. This trigger 42 allows the weapon shot to be triggered. As with a conventional weapon, the firing weapon 39 also comprises a magazine retainer 43 situated on the side of the grip 40. Usually, this retainer 43 allows the weapon to be reloaded by cartridge. It is activated with the thumb of the player.

In the mouse of the invention, the player places his hand around the grip 40, with the thumb near the retainer 43 and the index finger against the trigger 42. In the invention, the trigger 42 comprises a first action button for the mouse; the retainer 43 comprises a second action button for the mouse. In other words, in the invention, the trigger 42 allows the functions that are generally implemented by the left action button of a conventional mouse to be implemented. The retainer 43 allows the functions that are generally implemented by the right action button of a conventional mouse to be implemented. For example, the trigger has the role of simulating the shooting in a video game when it is activated, and the retainer 43 has the role of simulating the cartridge reloading function of the weapon when it is activated. In this example, the role of the trigger and the role of the retainer of the mouse of the invention are roughly identical to the role of a trigger and a retainer in a real weapon except that, in the invention, the weapon is fake. The player thus has the impression that he is really firing with a weapon.

However, the trigger 42 and the retainer 43 of the dummy weapon 39 may allow any functionality that is generally activated from one of the action buttons of a conventional mouse to be activated.

In a preferred embodiment of the invention, the hammer 44 of the dummy weapon 39, situated behind the weapon breech, allows a third function to be activated, which will be described later.

In FIG. 3 is represented the mouse of the invention in an exploded view. Thus one can see the housing 31 that comprises a baseplate 32 forming the housing base of the mouse of the invention. This housing 31 also comprises an upper shell 36 designed to fit into the baseplate 32. This shell 36 has a rounded shape that roughly follows the shape of the palm of a hand. The baseplate 32 and the shell 36 have complementary shapes that allow them to fit one into the other, as with a conventional mouse.

Inside the housing 31, a printed circuit 34 allows the usual functions of a computer mouse to be performed. A scroll wheel 35 may be inserted into an orifice made for this purpose in the printed circuit 34. The printed circuit 34, like the scroll wheel 35, are identical to the printed circuits and scroll wheels of mice that are conventionally found in business.

In the case where the printed circuit 34 comprises a scroll wheel 35, the upper shell 36 of the housing 31 comprises an orifice allowing the passage of a part of this scroll wheel.

The scroll wheel 35 generally has two functions: a first function implemented by causing the wheel to turn and a second function implemented by pushing on the wheel. The first function allows different choices or options that are opened to the player to be caused to scroll on the television screen or computer screen. The second function allows the chosen option to be selected.

In an embodiment of the invention, the shell 36 of the housing 31 comprises means for fixing the dummy weapon 39 on said housing. As shown in FIG. 3, these fixation means may be an indentation 36′ achieved on the upper side of the shell 36 in which the grip 40 of the weapon fits into and is possibly glued. The fixation means may also be a screw/nut system crossing the shell and the grip for fixing them to each other or rather a lug and mortise system allowing the grip to be fitted into the shell. The fixation means may also be a combination of these different means.

In another embodiment, the dummy weapon may be molded with the shell 36 of the housing 31.

In the embodiment represented in FIG. 3, the mouse is a ball mouse, that is, in which the directional sensor is a ball. This ball is referenced 33. In another embodiment, the mouse may be an optical mouse, that is, in which the directional sensor is an optical type sensor.

In the invention, an interrupter 46b is placed inside the weapon near the trigger 42 of the dummy weapon 39. This interrupter 46b is connected by an electric connection wire 38 to an electric contact zone 46a situated on the printed circuit 34 of the mouse. This contact zone is situated at the site of the interrupter of the left action button of a conventional mouse. The trigger 42, interrupter 46b and contact zone 46a together comprise the first action button of the mouse of the invention.

Thus, during a video game, when the player wants to shoot on a target, he activates the trigger 42 by pulling it toward the grip of the weapon. The part of the trigger situated inside the weapon, and represented in dots in FIG. 3, is then displaced toward the interrupter 46b. By touching it, the trigger activates the interrupter 46b that sends, by the wire 38, an electric pulse to the contact zone 46a. The electric pulse is then transmitted to the printed circuit in the same way as with a conventional mouse.

Identically, a second interrupter 48b is placed inside the weapon near the retainer 43 of the dummy weapon 39. This second interrupter 48b is connected, by an electric connection wire 49, to a second electric contact zone 48a situated on the printed circuit 34 of the mouse. This contact zone is situated at the site of the interrupter of the right action button of a conventional mouse. The retainer 43, second interrupter 48b and second contact zone 48a together comprise the second action button of the mouse of the invention.

As with the trigger 42, when the player wants to reload his weapon by cartridge, he pushes on the retainer, which displaces the part of the retainer situated inside the weapon. By displacing it, the retainer activates the second interrupter that sends an electric pulse to the second contact zone on the printed circuit.

In the embodiment of the invention represented in FIG. 3, the hammer 44 of the dummy weapon 39 is used to activate a third function of the mouse. This third function corresponds to the function of pushing on the scroll wheel of a conventional mouse. As explained previously, the scroll wheel 35 has a first scroll function and a second function of selecting one of the scrolling options. In the embodiment of FIG. 3, a third interrupter 47b is placed inside the weapon near the hammer 44 of the dummy weapon 39. This interrupter 47b is connected by an electric connecting wire 37 to an electric contact zone 47a situated on the printed circuit 34 of the mouse. This contact zone 47a is situated at the site of the interrupter of the scroll wheel of a conventional mouse. The hammer 44, interrupter 47b and contact zone 47a together comprise the third action button of the mouse of the invention.

As with the trigger 42 and the retainer 43, when the player pushes on the hammer, that is, when he pushes the hammer toward the housing, this displaces the part of the hammer situated inside the weapon, represented in dots in FIG. 3. By displacing it, the hammer 44 activates the interrupter 47b that sends, by the wire 37, an electric pulse toward the contact zone 47a. The electric pulse is then transmitted, by the zone 47a, to the printed circuit 34 in the same way as in a conventional mouse.

In a variation of the invention, the hammer may have a more sophisticated function with an interrupter at 4 positions (front, back, left and right) or even at 8 positions or a mini-joystick in order that the player may control certain displacements in the game with the hammer, like the displacement of a game character. In the case where the hammer has the function of a mini-joystick, the third action button comprises a potentiometer instead of an interrupter. In this case, the part of the hammer situated inside the weapon is mechanically connected to the cursor of the potentiometer. Thus, when the player pushes on the hammer, this displaces the cursor of the potentiometer that sends an electrical signal to the contact zone 47a.

For each of these action buttons described previously, the player, by pushing on an element of the dummy weapon, creates a movement of this element. This element, by touching the near interrupter, has a mechanical effect and this mechanical effect leads to an electric command.

To allow the housing to be comfortable in the position of the player's hand, the housing of the mouse preferably is in a shape that is sufficiently large so as to support the side of the hand of the player when he takes the weapon.

In a variation of the invention, a retainer button of the magazine may be implanted in each side of the dummy weapon to ensure a comfortable utilization for both right-handed and left-handed players. In other words, a first retainer may be placed on the left side of the weapon so as to be under the thumb of right-handed players and a second retainer may be placed on the right side of the weapon so as to be under the thumb of the left-handed players.

With these three action buttons, the computer mouse of the invention closely simulates the reality of shooting movements, facing the game display screen. Furthermore, it is to be noted that the shooting elements (trigger, retainer and hammer) of the dummy weapon retain the same characteristics of a real weapon, that is, an identical movement and noise.

In an embodiment of the invention, the computer mouse is equipped with a mechanism, run by an electric motor, ensuring the movement of the breech when the player pushes on the trigger, thus simulating the movement of the breech of a real semi-automatic pistol or a real submachine gun and also simulating the vibrations.

In this way, a player who takes the computer mouse of the invention in hand has the impression of holding a weapon and not of holding a computer mouse.

In a variation of the invention, the dummy weapon 39 emits a laser beam in the direction of the display screen with each shot.

1. A computer mouse for video games, comprising,
a housing, and a first and a second action buttons;
a dummy firing weapon fixed above the housing adapted for and manipulation by a video game player, and
the first action button oriented on the weapon, at the location where the player's index finger is placed, and a second action button oriented on the weapon, at the location where the player's thumb is placed.

2. The computer mouse according to claim 1, the first action button comprising a weapon trigger.

3. The computer mouse according to claim 1, the second action button comprising a magazine retainer for the weapon.

4. The computer mouse according to claim 2, the first action button comprising an interrupter placed near the weapon trigger.

5. The computer mouse according to claim 3, the second action button comprising an interrupter placed near the weapon retainer.

6. The computer mouse according to claim 1, the mouse comprising a third action button comprising the weapon hammer.

7. The computer mouse according to claim 6, the third action button comprising an interrupter placed near the weapon hammer.

8. The computer mouse according to claim 6, the third action button comprising a potentiometer placed near the weapon hammer.

9. The computer mouse according to claim 1, the weapon emits adapted for emitting a laser beam in the direction of a video game display device.
